(19) United States
(12) Patent Application Publication
(10) Pub. No.: US 2004/0133912 A1
(43) Pub. Date: Jul. 8, 2004

(54) Method and apparatus of IEEE 1394 tone transmission in beta mode

(76) Inventors: Chris Thomas, San Diego, CA (US); Jun Ye, San Diego, CA (US)

Correspondence Address: Karl M. Steins, Steins & Associates, Suite 120, 2333 Camino del Rio South, San Diego, CA, 92108, US

(21) Appl. No.: 10/688,486

(22) Filed: Oct. 16, 2003

Related U.S. Application Data
(60) Provisional application No. 60/420,185, filed on Oct. 22, 2002.

(51) Int. Cl. H04N 7/18

(52) U.S. Cl. 725/80; 725/82

(57) ABSTRACT

A Method and Apparatus of IEEE 1394 Tone Transmission in Beta Mode is disclosed. The invention relates to a method for the transmission of clock signal in IEEE 1394 beta mode, known as “tone.” The system comprising a controller for automatic adjustment of the level of power consumption of the device responsive to whether or not an effective bus connection is being made, a current reference having temperature compensation, a self-calibrating oscillator, a “tone” transmitter, a “tone” receiver, and termination circuitry. While in standby mode, and when no cable is interconnecting the device to another device, the device transmits tones and listens for incoming tones while maintaining low power consumption. When a cable is plugged in, the device awakens automatically and resumes normal IEEE 1394 transmissions.

This application claims priority to provisional application serial No. 60/420,185, filed Oct. 22, 2002.

### BACKGROUND OF THE INVENTION

1. Field of the Invention

This invention relates generally to IEEE 1394 communications and, more specifically, to a Method and Apparatus of IEEE 1394 Tone Transmission in Beta Mode.

2. Description of Related Art

The standard cable media which provides remote coupling of two IEEE 1394 devices is the IEEE 1394 cable, commonly referred to as the “Firewire” cable. A firewire cable can be made from a variety of different cable media, including 1394 cable, category 5 UTP cable, or optical fiber. Unlike the conventional “alpha” mode, when a 1394 device is in “beta” mode, it relies upon receiving a tone signal from a device connected to the other end of a firewire cable in order for the device to enter into the “discovery” phase leading to the establishment of a 1394 link. When a cable is not connected to the device, the conventional termination resistor arrangement in the circuit results in relatively large power consumption across the transmitter. This situation is particularly damaging to battery-powered 1394 devices, since they typically only have a firewire cable connection for short periods of time—most of their operating time is spent with the cable unplugged, thereby causing substantial drain on the battery charge. Turning to FIG. 1, we can discuss the prior art circuitry design.

According to the IEEE 1394 protocol (beta mode), in the unconnected mode, the transmitter is required to transmit a tone signal, while simultaneously the receiver is searching for an incoming tone signal. When two 1394 devices are being connected to one another through a firewire cable, the receiver on one side receives the transmitted tone from the other device, and the controller recognizes the establishment of the link. Thereafter, both devices start normal transmission.

FIG. 1 is a simplified circuit diagram of a conventional IEEE 1394 transceiver circuit 10. The circuit 10 comprises a receive pair 12A and a transmit pair 12B, each being connectable to a firewire cable. Both pairs 12A and 12B include termination resistor modules 14A and 14B, respectively, provided in order to provide impedance matching between interconnected devices.

The receiver 16 output is fed to the transceiver controller 18 for detecting when a tone is sent by a connected device. The controller 18 further controls a crystal oscillator 20, which generates the tone signal for transmission by the transmitter 22 via the transmit pair 12B. The operation of the transceiver 10 is discussed in FIG. 2.

FIG. 2 is a flow chart depicting the discovery method of the conventional IEEE 1394 transceiver 30. After startup 100 of the transceiver, termination is enabled 102 (and continues to be enabled constantly in beta mode). If a connection is detected 104 (i.e. a tone is detected), then the transceiver is enabled 108. If no connection is detected, the circuit continues to wait 106 until a connection is detected 104.

In the unconnected mode, the transmitter's 22 output is terminated with small resistors (collectively 14B). As the transmitter 22 transmits a tone signal (which has to be above a certain amplitude in voltage in order to be detected/received by the other device), there is a large power consumption across the termination resistors 14B. As a result, a battery powered device is unable to operate efficiently since most of the time the cable is unplugged and the IEEE 1394 device is in unconnected mode (and transmitting tone).

One attempt at solving this problem is to disable the tone transmission on battery-powered devices. This works when a battery-powered device is connected to a non-battery-powered device, since at least one side will receive the tone (which is the condition for two IEEE 1394 beta mode devices to leave the tone mode and enter the communication mode). This approach does not solve the power drain problem, however, when two battery-powered devices are interconnected.

### SUMMARY OF THE INVENTION

In light of the aforementioned problems associated with the prior devices and methods, it is an object of the present invention to provide a Method and Apparatus of IEEE 1394 Tone Transmission in Beta Mode. The method and apparatus should provide an IEEE 1394 tone transmission in beta mode having optimized power efficiency.

According to a first aspect of the present invention, there is provided a method for transmitting a IEEE 1394 tone signal with power efficiency, including responsively disconnecting the termination resistors in the unconnected mode, and further replacing the crystal oscillator with a low-power-consuming internal oscillator that is calibrated against the crystal oscillator in the normal transmission mode and compensated for changes of temperature and power supply voltage.

According to a second aspect of the present invention, there is provided an apparatus for transmitting a IEEE 1394 tone signal with power efficiency, including means for responsively disconnecting the termination resistors when the device is in the unconnected mode, and further means for replacing the crystal oscillator with a low-power-consuming internal oscillator, wherein the inherent inaccuracies of the internal oscillator due to temperature and power supply voltage variation are compensated for by an internal calibration method.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a circuit diagram of a conventional IEEE 1394 transceiver;

FIG. 2 is a flow chart depicting the discovery method of the conventional IEEE 1394 transceiver;

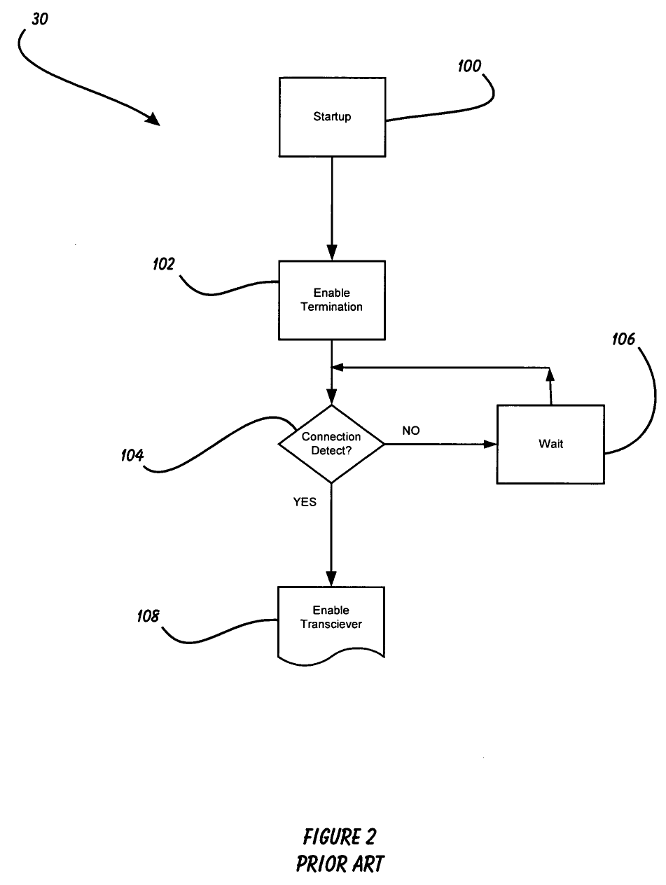

FIG. 3 is a circuit diagram of the IEEE 1394 transceiver of the present invention having improved standby mode;

FIG. 4 is a flow chart depicting the discovery method of the IEEE 1394 transceiver of FIG. 3;

FIG. 5 depicts the elements of two interconnected IEEE 1394 devices;

FIG. 6 is a diagram depicting the architecture of the calibration of the current-controlled oscillator of the device of FIG. 3;

FIG. 7 is a circuit diagram of the current controlled oscillator of FIGS. 3 and 6; and

FIG. 8 is a circuit diagram of the current reference generator having temperature compensation of FIG. 3.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Method and Apparatus of IEEE 1394 Tone Transmission in Beta Mode.

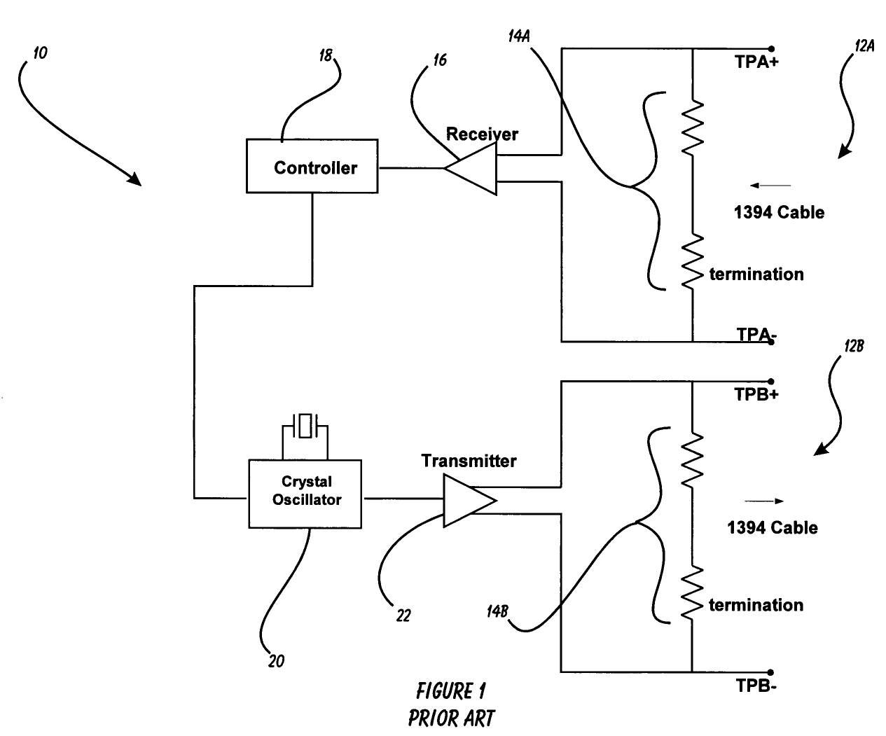

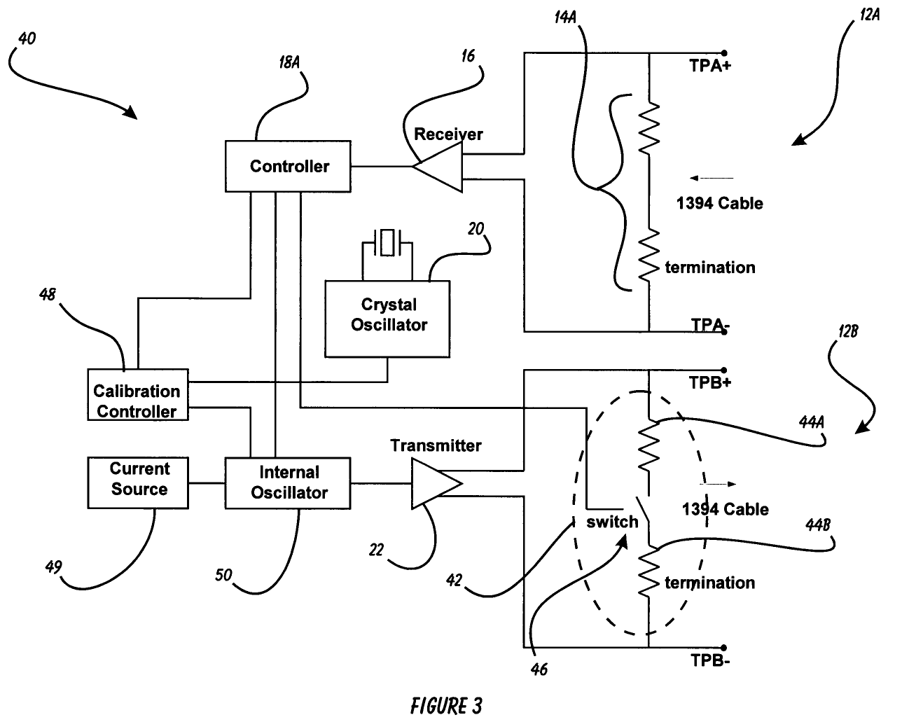

The present invention can best be understood by initial consideration of FIG. 3. FIG. 3 is a circuit diagram of the IEEE 1394 transceiver of the present invention having improved standby mode 40. There are essentially three modifications to the conventional transceiver circuit (see FIG. 1) that result in the circuit 40 depicted here. First, the termination resistor module 14B is replaced with the termination resistor module 46 depicted here. The new module 46 has a pair of termination resistors 44A and 44B, but further has a switch means 46 that can act to short out the resistors 44. The switch means 46 is responsive to commands generated in the controller 18A, which is modified over the conventional controller to serve this function (among others). When the resistors 44 are shorted out (i.e. in the unconnected mode on a battery-powered device), there is a high impedance on the transmitter's 22 output when a cable is not present. As a result, low power consumption is achieved.

Second, an internal oscillator 50 is added to the system 40. The beta mode tone signal is required to have a certain precision; a crystal oscillator 20 is generally used to produce the clock reference signal in order to obtain this precision. The problem is that the crystal oscillator 20 consumes large amounts of power when in operation. In order to obtain further power efficiency, an internal low-power-demand oscillator 50 is used for clock reference when the device is in beta tone mode. In order to obtain the requisite accuracy from this low-power oscillator, additional calibration and compensation for temperature and power supply voltage is required. The internal oscillator 50 uses a current reference 49.

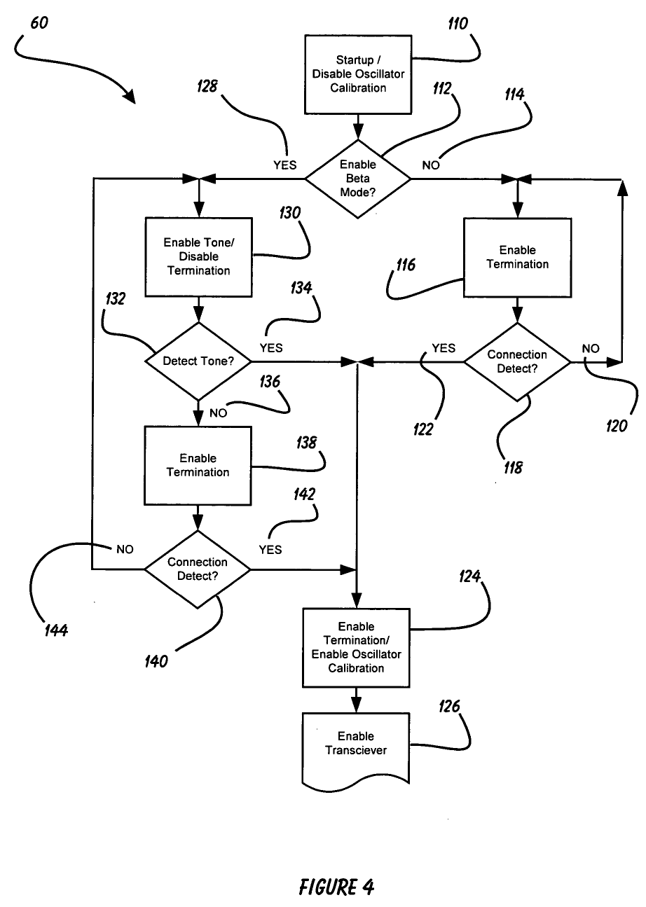

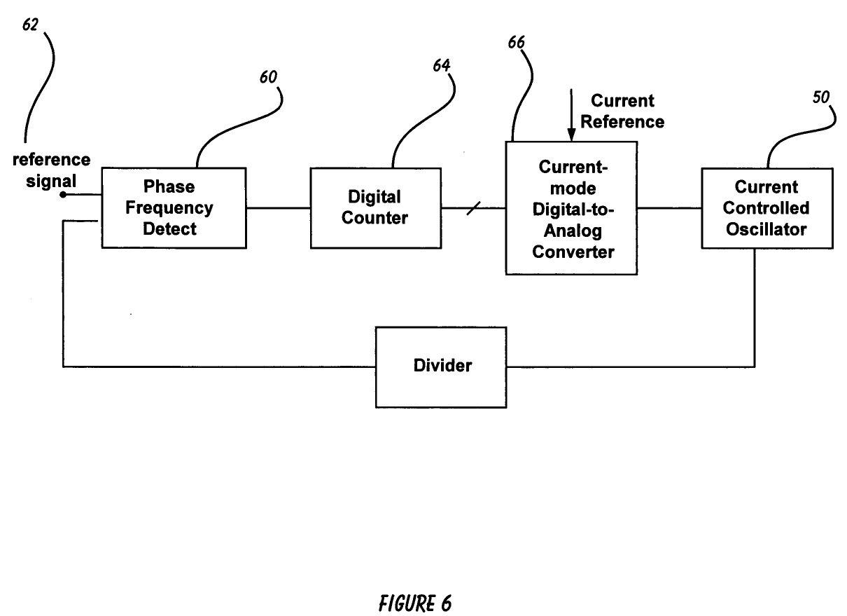

Third, a calibration controller 48 is added to the circuit 40 in order to calibrate the internal oscillator 50 to the reference signal generated by the crystal oscillator 20 when IEEE 1394 communications are established. Further detail regarding this calibration process is provided below in the discussion related to FIG. 6. If we turn now to FIG. 4, we can review how the new circuit operates.

FIG. 4 is a flow chart depicting the discovery method 60 of the IEEE 1394 transceiver of FIG. 3. At startup 110, the calibration of the internal oscillator 50 is disabled. If beta mode is not enabled 114, then termination is enabled 116 (in alpha mode); if no connection is detected 120, then the device waits until a connection is detected 122. Once connection is detected 122, termination is enabled and the internal oscillator 50 is calibrated according to the method of FIG. 6.

If beta mode is enabled 128, then tone is enabled, but termination is disabled 130. Disabling the termination 130 is accomplished by opening switch means 46 and shorting out the resistors 44. Periodically, on a preset interval, termination is enabled 138 (the switch means is closed) and a tone is generated (in alpha mode). If connection is detected in this alpha mode 142, then termination is enabled and oscillator calibration is conducted 124, and the transceiver is enabled 126. If connection is not detected 144, then termination is disabled on the transmit pair 12B.

If tone is detected 134 at step 132, then termination is enabled and oscillator calibration is conducted 124, and then the transceiver is enabled 126 for communications.

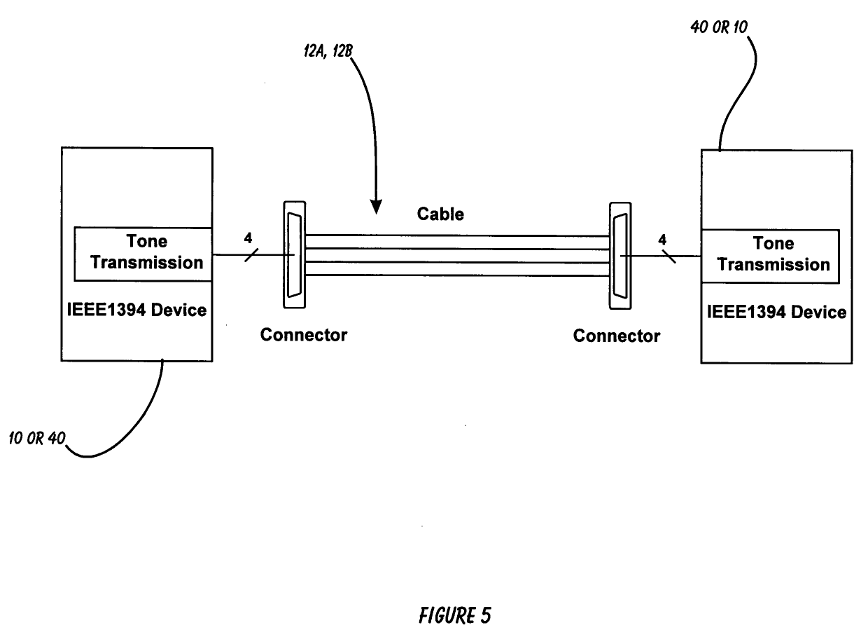

FIG. 5 depicts the elements of two interconnected IEEE 1394 devices 40 or 10. By design, a device having the circuit 40 of the present invention complies with the IEEE 1394 standards, and therefore it can communicate with a legacy device of the prior design 10.

FIG. 6 is a diagram depicting the architecture of the calibration of the current-controlled oscillator 50 of the device of FIG. 3. When calibration is called for (see FIG. 4), the phase/frequency detector 60 compares the frequency of the reference signal 62 generated by the crystal oscillator 20 to the frequency of the signal being generated by the current controlled oscillator 50. The phase/frequency detector 60 then responsively generates either an “up” or a “down” signal, depending upon the comparison. The digital counter 64 counts that signal and then a current mode analog-to-digital converter 66 converts the digital count into an analog current. The level of this analog current determines the frequency of oscillation of the internal oscillator 50. This closed loop control process will continue until the digital counter 64 freezes, thereby indicating that the proper frequency has been reached and the output frequency of the oscillator 50 is then stabilized.

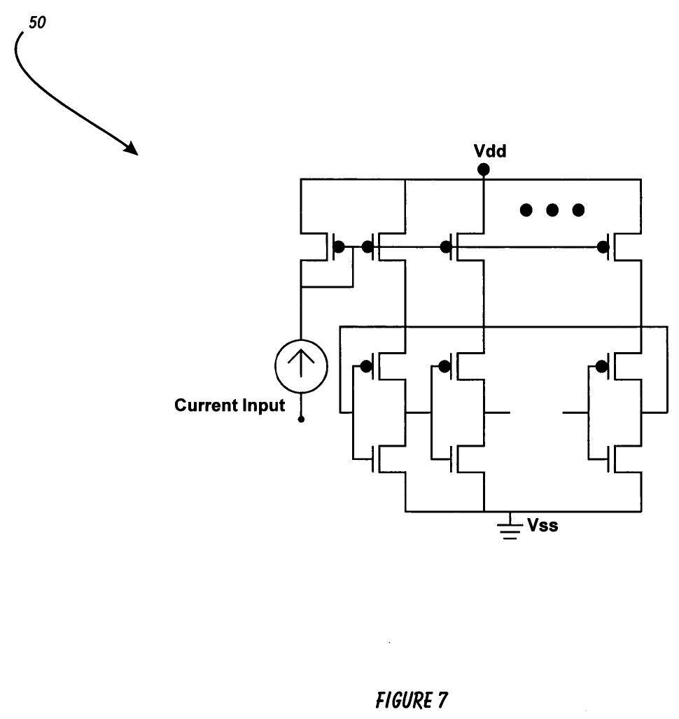

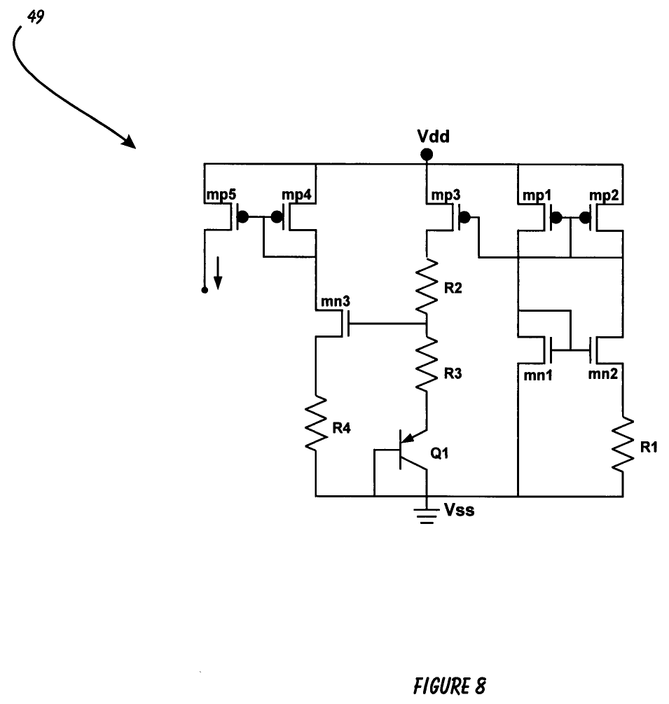

Unfortunately, temperature and power supply voltage variation can have an effect on the tendency of the internal oscillator's 50 frequency to drift. In order to maintain precise oscillation frequency between calibrations, additional compensation is necessary, as depicted in FIGS. 7 and 8.

FIG. 7 is a circuit diagram of the current controlled oscillator 50 of FIGS. 3 and 6. FIG. 8 is a circuit diagram of the current reference generator having temperature compensation 49 of FIG. 3. The circuit is capable of generating constant current with a slightly positive temperature coefficient (when temperature increases, current output increases by a small amount). Coincidentally, the oscillator 50 has a slightly negative temperature coefficient (when temperature increases, oscillation frequency slows down). The combined result of the temperature coefficients of the oscillator 50 and reference current generator 49 is to cancel out temperature effects on frequency. Furthermore, operating the oscillator 50 in current mode makes the oscillator 50 insensitive to variations in power supply voltage as well. As a result, the low-power-demand current controlled oscillator 50 substantially reduces power demands on the system, while still providing the requisite frequency accuracy for tone generation under IEEE 1394 protocol.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An IEEE1394 tone transmission method in beta mode comprising:
a controller for automatic adjustment of power consumption level of the device as to whether or not an effective bus connection being made, a current reference with temperature compensation, a self-calibrated oscillator, a “tone” transmitter, a “tone” receiver, and termination circuitry.

2. An IEEE1394 tone transmission method in beta mode according to claim 1, wherein it automatically adjusts power consumption level when the cable is not plugged in.

3. An IEEE1394 tone transmission method in beta mode according to claim 2, wherein the termination resistors are disconnected when the cable is not plugged in.

4. An IEEE1394 tone transmission method in beta mode according to claim 1, wherein the oscillator is calibrated during the normal transmission when the cable is plugged in.

5. An IEEE1394 tone transmission method in beta mode according to claim 1, further comprising shutting down all circuits other than the current source, the oscillator, the tone transmitter, and the tone receiver, and disabling the termination resistors while the cable is unplugged.

6. An IEEE1394 tone transmission method in beta mode according to claim 1, further comprising automatically detecting the cable connection and connecting the termination resistors after cable connection is detected.

7. An IEEE1394-compliant transceiver, comprising:
a receive pair interconnected by a first resistor module;
a receiver connected to said receive pair;
a controller connected to said receiver;
a current-controlled oscillator controlled by said controller;
a calibration controller for calibrating said current-controlled oscillator to a reference frequency;
a transmitter for transmitting a signal generated by said current-controlled oscillator;
a second termination resistor module defined by at least one resistor and switch means for shorting said resistor responsive to said controller; and
a transmit pair connected to said second termination resistor module.

8. The transceiver of claim 7, wherein said controller defines an enable termination mode and a disable termination mode, said controller controlling said switch means to short said at least one resistor in said disable termination mode and to close said switch means circuit with said at least one resistor in said enable termination mode.

9. The transceiver of claim 8, further comprising a reference signal generator for generating said reference frequency.

10. The transceiver of claim 9, wherein said reference signal generator comprises a crystal oscillator.

11. The transceiver of claim 7, wherein said calibration controller comprises a phase/frequency detector for comparing said reference frequency to a signal generated by said current-controlled oscillator and generating a control signal.

12. The transceiver of claim 11, wherein said calibration controller comprises a digital counter for collecting said control signal from said phase/frequency detector.

13. The transceiver of claim 12, wherein said calibration controller comprises a digital-to-analog converter for converting a signal generated by said digital counter into an analog current signal.

14. The transceiver of claim 7, wherein said controller is responsive to an IEEE1394-compliant cable being connected to said receive pair, said controller thereafter responsively adjusting to enable termination mode and commanding said switch means to close said circuit to said at least one resistor.

15. An IEEE 1394-compliant tone transmission apparatus in beta mode, the apparatus comprising:
a current source;
a current controlled oscillator connected to said source;
a means for calibrating tone frequency generated by said oscillator during normal transmission and further transmitting tone signal at a constant frequency during IEEE1394-compliant standby mode when a cable is not plugged into said apparatus;
wherein said constant frequency is achieved through temperature and voltage stabilization means associated with said current source and said oscillator.
